(19) United States
(12) Patent Application Publication
(10) Pub. No.: US 2007/0273267 A1
(43) Pub. Date: Nov. 29, 2007

(54) IMAGE DISPLAY DEVICE

(75) Inventors: Tokutaka Miura, Yokohama-shi (JP); Mitsutoshi Hasegawa, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/749,954

(22) Filed: May 17, 2007

(30) Foreign Application Priority Data
May 26, 2006 (JP) 2006-146308

(51) Int. Cl. H01J 63/04; H01J 1/62

(52) U.S. Cl. 313/495; 313/497

(57) ABSTRACT

An image display device comprises: a front substrate having a fluorescent member for displaying an image, and a metal back for covering the fluorescent member; a rear substrate having an electron emission element; and a support frame disposed between the front substrate and the rear substrate. In the image display device, a thickness of the metal back is 55 nm or more and 120 nm or less, and at least the metal back is covered with a getter. Thus, since the metal back of the front substrate is covered with the getter, a time-dependent deterioration of luminance is small and a lifetime is long even if a potential of the metal back is high.

### BACKGROUND OF THE INVENTION

1. Field of the Invention

The present invention relates to an image formation unit of an image display device, and, more particularly, to the constitutions of a metal back and a getter of a front substrate used in a flat panel image display device.

2. Description of the Related Art

Generally, since an electron beam is used in a CRT (Cathode Ray Tube) and an FPD (Flat Panel Display), it is necessary to maintain high vacuum inside a vacuum vessel. That is, deterioration of the vacuum (i.e., an increase of pressure) in the vacuum vessel affects image quality and a lifetime of an electron source, whereby a metal thin film called a getter is disposed within the vacuum vessel. Here, according as a display area of an image display device enlarges in recent years, it is necessary to prepare and dispose the getter having a sufficiently large area within the vacuum vessel. In this connection, Japanese Patent Application Laid-Open No. H09-082245 discloses an image display device in which a getter is disposed on a metal back covering a fluorescent member.

In Japanese Patent Application Laid-Open No. H09-082245, an appropriate thickness of the metal back is selected from 50 nm or less, and an appropriate thickness of the getter is selected from 30 nm or more and 50 nm or less. However, if a potential applied to the metal back is higher, an amount of gas released from the side of the fluorescent member increases, whereby further improvement is requested.

### SUMMARY OF THE INVENTION

The present invention provides an image display device which has a getter on a metal back, and in which a time-dependent deterioration of luminance is small and a lifetime is long even if a potential of the metal back is high.

To do so, the present invention is characterized by the image display device comprising: a front substrate having a fluorescent member for displaying an image, and a metal back for covering the fluorescent member; a rear substrate having an electron emission element; and a support frame disposed between the front substrate and the rear substrate, wherein a thickness of the metal back is 55 nm or more and 120 nm or less, and at least the metal back is covered with a getter.

Further features of the present invention will become apparent from the following description of the exemplary embodiments with reference to the attached drawings.

### BRIEF DESCRIPTION OF THE DRAWINGS

FIG. 1 is a schematic diagram illustrating one example of an SED (Surface-conduction Electron-emitter Display) using an SCE (Surface Conduction Electron-emitter).

FIG. 2 is a schematic diagram illustrating a part of the cross section of the front substrate of the SED illustrated in FIG. 1.

FIG. 3 is a diagram illustrating a time-dependent change of luminance according to an exemplary embodiment of the present invention.

### DESCRIPTION OF THE EXEMPLARY EMBODIMENTS

The present invention is characterized by an image display device comprising: a front substrate having a fluorescent member for displaying an image, and a metal back for covering the fluorescent member; a rear substrate having an electron emission element; and a support frame disposed between the front substrate and the rear substrate, wherein a thickness of the metal back is 55 nm or more and 120 nm or less, and at least the metal back is covered with a getter.

Further, in the present invention, it is preferable that a thickness of the getter is 40 nm or more and 200 nm or less. Moreover, it is preferable that the getter is an alloy including Ti, Zr, or at least one kind of Ti and Zr as a main component.

According to the present invention, in the image display device in which the metal back of the front substrate is covered with the getter, a time-dependent deterioration of luminance is small and a lifetime is long even if a potential of the metal back is high.

In the following, the exemplary embodiments of the present invention will be described in detail with reference to the attached drawings.

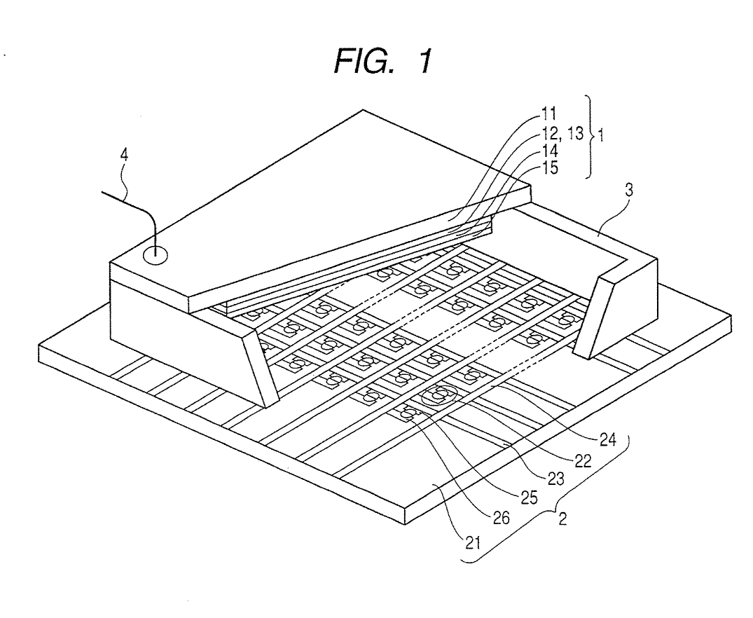

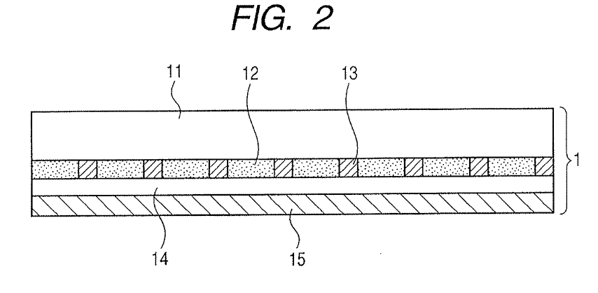

FIG. 1 is a schematic diagram illustrating one example of the constitution of the image display device according to the present invention. In FIG. 1, a front substrate 1, a rear substrate 2 and a support frame 3 are mutually adhered by using a frit glass or a low-melting metal at junctions respectively, thereby forming an envelope (i.e., a vacuum vessel). More specifically, the front substrate 1 is formed by setting up a fluorescent member 12, a black matrix 13, a metal back 14 and a getter 15 on a front grass substrate 11, and the front substrate 1 acts as an image display range. FIG. 2 is a schematic diagram illustrating the enlarged cross section of the front substrate 1. In a case where the image display device displays a black-and-white image, the fluorescent member 12 includes only a fluorescent member. On the other hand, in a case where the image display device displays a color image, pixels are made by fluorescent members of three primary colors of red (R), green (G) and blue (B) respectively, and the adjacent pixels are separated by a black conductive material. Here, it should be noted that the black conductive material is called a black stripe, a black matrix or the like according to the shape thereof. The metal back 14 is formed by a conductive thin film such as Al or the like. A light, from among lights generated from the fluorescent member 12, advancing toward an electron emission element 22 is reflected by the metal back 14 in the direction of the front glass substrate 1, thereby increasing luminance. At the same time, the metal back 14 works to prevent that the residual gases in the envelope damage the fluorescent member on impact of ions generated by ionization of the gases due to electron beams. Moreover, the metal back 14 works to render conductivity to the image display range of the front substrate 1 to as to prevent electrical charges from being accumulated. In this case, the metal back 14 acts as an anode electrode for the electron emission element 22. Incidentally, the metal back 14 is connected to a high voltage deriving terminal 4, whereby a voltage is externally applied to the metal back 14.

The getter, which adsorbs the gases generated inside the envelope, can be formed on the metal back 14 by a vacuum vapor deposition method, a sputtering method or the like. Particularly, in case of forming a non-rable getter (NEG), it is preferable to stabilize the getter 15 by forming a thin nitride layer on the surface of the getter 15 so as to facilitate handling of the formed getter 15. To do so, a nitride gas is introduced into a vacuum device after forming the getter 15. The nitride layer formed at this time is then eliminated by a getter activation process. Here, it should be noted that, in the getter activation process, nitrogen atoms are diffused inside the getter material through a vacuum heating method or the like to form a clean surface, thereby effecting a getter process (gas adsorption process). Incidentally, the preferable getter to be used in the present invention is the NEG, and it is preferable to select the material of the NEG from among Ti, Zr, and an alloy including at least one of Ti and Zr as a main component.

Although it depends on a kind of gas, an amount of gases capable of being adsorbed by the getter 15 depends on the cubic content of the getter film because the gases are diffused inside the getter. Therefore, the lower limit of the thickness of the getter film is determined according to a necessary adsorption amount. That is, this thickness is preferably 30 nm or more. Particularly, in case of forming the NEG, since the gases are diffused inside the getter in the getter activation process, the available cubic content corresponding to such diffusion is consumed. In any case, in case of forming the NEG on the image display range of the front substrate, there is a possibility that the thickness of about 40 nm or so is unavailable, whereby it is preferable for the getter film to have the thickness of at least 40 nm or more.

To reduce the unavailable thickness of the getter film, it is conceivable to reduce, in the getter activation process, the amount of the gases to be diffused inside the getter. That is, the gases diffused inside the getter 15 in the getter activation process include the gas adsorbed on the surface of the getter 15 and the gas diffused through the metal back 14 acting as the base of the getter 15. Here, with respect to the gas already adsorbed on the surface of the getter 15, it is not easy to reduce the amount diffused inside the getter 15. However, it was probed that the amount of the gas diffused through the metal back 14 can be reduced by increasing the thickness of the metal back 14. As a result of studies, it was probed that, if the thickness of the metal back 14 is adjusted to about 55 nm or more, the amount of the gas to be diffused inside the getter 15 through the metal back 14 can be reduced.

However, it was also probed that, if the thickness of the metal back 14 exceeds 55 nm and reaches 120 nm or so, adsorption performance of the getter 15 rather deteriorates. This is because the amount of the gas capable of being adsorbed by the getter 15 depends on roughness of the surface of the metal back 14 acting as the base of the getter 15. More specifically, if the thickness of the metal back 14 increases to 120 nm or so, the surface of the metal back 14 is smoothed, whereby the roughness of the surface of the metal back 14 decreases. In other words, the upper limit of the thickness of the metal back 14 is 120 nm or so.

With respect to the rear substrate 2, the electron emission element 22 is formed at the location, on a rear glass substrate 21, corresponding to and substantially opposed to each of the fluorescent member 12 on the front substrate 1, and the electron emission element 22 is connected to an X-direction wiring 23 through an element electrode 25 and to a Y-direction wiring 24 through an element electrode 26. Here, it should be noted that the Y-direction wiring 24 is a column selection terminal for selecting the column of the element from which an electron is emitted, and the X-direction wiring 23 is a signal input terminal through which a signal for controlling an electron emission amount of the elements belonging to the selected column is input. Incidentally, it should be noted that the shapes of these terminals are desirably selected according to the constitution of the electron emission element 22 and a method of controlling the electron emission element 22. Namely, the shapes of these terminals are not limited to those illustrated in FIG. 1.

The front substrate 1 and the rear substrate 2 are disposed to be opposed to each other through the support frame 3, and they are sealed by using a sealing material such as a frit or a low-melting metal, whereby an FPD (Flat Panel Display) including a vacuum vessel is formed. Incidentally, with respect to an FED (Field Emission Display) or an SED (Surface-conduction Electron-emitter Display) of which the inside has to be vacuumized, a method of sealing a target in a vacuum chamber, a method of sealing a target, and then evacuating air through an exhaust duct, an exhaust hole or the like is applicable as a vacuumizing method. In the getter activation process, it is necessary to increase a temperature in a vacuum. In particular, if the NEG such as Ti, Zr or the like is applied, since a gas mainly including hydrogen is generated from the getter, it is desired to execute the getter activation process before the vacuum vessel is sealed.

A cable is implemented on the panel which was sealed and in which vacuum has been maintained, so as to connect the panel with a driving circuit. The panel is then built in a housing, and the FPD is formed. Incidentally, a driving circuit is usually implemented in a display to be used in a TV receiver, a PC (personal computer) or the like. However, a driving circuit is not implemented in the present invention. That is, even if a driving signal is externally input from an independent driving circuit, there is no difference.

### EXAMPLES

Hereinafter, the present invention will further be described with reference to examples.

### Example 1

(1) Front Substrate Forming Process

As the front glass substrate 11, a thick glass “PD-200” (manufactured by ASAHI GLASS Co. Ltd.) of 2.8 mm having few alkaline components is used. After the glass substrate was sufficiently washed off, ITO (Indium-Tin Oxide) of 100 nm is deposited on the glass substrate by a sputtering method, thereby forming a transparent electrode. Subsequently, a fluorescent film is applied by a printing method to execute a surface smoothing process called “filming”, thereby forming the fluorescent member 12. Incidentally, the fluorescent member 12 has a matrix constitution (called a black matrix) in which striped fluorescent members of red, green and blue three colors and a black conductive member are alternately arranged. Further, one pixel includes red, green and blue, and the number of pixels is 720×160. Furthermore, the metal back 14 of 100 nm including an aluminum thin film is formed on the fluorescent member 12 and the black matrix 13 (that is, the whole surface of the image display unit) by an electron beam vapor deposition method. Then, after metal back was formed, the filming is eliminated by baking the glass substrate in the atmosphere. Incidentally, the wiring for electrically connecting the metal back 14 with the high voltage deriving terminal 4 is previously formed by printing and baking an Ag paste.

(2) Getter Forming Process

After the filming was eliminated, Ti of 120 nm is formed on the upper whole surface of the metal back 14 by the electron beam vapor deposition method.

(3) Rear Substrate Forming Process

As the rear glass substrate 21, a thick glass “PD-200” (manufactured by ASAHI GLASS Co. Ltd.) of 2.8 mm having few alkaline components is used. Further, an SiO₂ film of 100 nm is applied and baked as a sodium block layer on the thick glass.

Each of the element electrodes 25 and 26 is formed by first forming a Ti film of 5 nm as an underlying film on the rear glass substrate 21 by the sputtering method, forming a platinum film of 40 nm on the Ti film by the sputtering method, applying a photoresist, and then executing patterning by a photolithography method successively including exposure, development and etching. Subsequently, the Y-direction wiring 24 is formed by a linear pattern so as to connect with one end of each of the element electrodes and interlink these element electrodes. More specifically, the linear pattern is first subjected to screen printing by using a silver photo-paste ink, the printed pattern is dried, and a predetermined pattern is exposed and developed. After then, baking is executed at 480° C. to form the wiring of which the thickness is about 10 μm and the width is 50 μm. Incidentally, since the end of the wiring is used as a wiring takeout electrode, the width thereof is made wider. Subsequently, an interlayer insulation film is disposed to insulate the X-direction wiring 23 and the Y-direction wiring 24 from each other. Below the X-direction wiring 23, a contact hole is formed so as to cover the intersection between the X-direction wiring 23 and the precedently formed Y-direction wiring 24 and to enable electrical connection between the X-direction wiring 23 and the other end of each of the element electrodes 25 and 26. More specifically, a photosensitive glass paste mainly including PbO is first subjected to the screen printing, the printed paste is exposed and developed, and such a series of processes is repeated four times. Then, the acquired film is baked at 480° C. The thickness of the interlayer insulation film is wholly about 30 μm, and the width thereof is 150 μm. The X-direction wiring 23 is formed by first executing the screen printing of a silver paste ink on the precedently formed insulation film and then drying the printed paste. Then, such a series of processes is repeated once on the precedently formed film (i.e., double coating), and the finally acquired film is baked at 480° C. The X-direction wiring 23 and the Y-direction wiring 24 intersect through the insulation film, and the X-direction wiring 23 is connected to the other end of the element electrode at the contact hole portion on the insulation film. Therefore, the other end of each of the element electrodes is interlinked to others, and the element electrodes act as a scanning electrode after the panel was formed. The thickness of the X-direction wiring 23 is about 15 μm.

(4) Applying of Element Film

An element film is applied between the element electrodes 25 and 26 by an inkjet method. Here, a solution containing organopalladium, which is produced by dissolving a palladium-proline complex of 0.15% by weight in an aqueous solution of 80% water and 15% isopropyl alcohol (IPA), is used as the element film. After then, the substrate to which the element film has been applied is baked in the air at 350° C. for ten minutes, thereby producing palladium oxide (PdO). Here, the diameter of the element film is about 60 μm and the thickness thereof is maximally 10 nm.

(5) Element Film Forming

An electricity conducting process in a reduction atmosphere (called a forming process) is executed to the element film formed on the rear substrate 2 so as to make a crack inside the element film, thereby forming an electron emission unit. More specifically, a cover is put on the whole substrate except for the peripheral deriving electrode portions of the rear substrate 2 (that is, the peripheral portion of the X-direction wiring 23 and the Y-direction wiring 24). Here, the cover is connected to a vacuum exhaust system and a gas introduction system so that the inside of the cover can be filled with a low-pressure hydrogen gas. Then, a voltage is applied between the X-direction wiring and the Y-direction wiring from an external power source through the electrode terminal portions in a low-pressure hydrogen gas room, to generate electrical conduction between the element electrodes 25 and 26, thereby partially destroying, modifying and transelementing the element film. Thus, the electron emission unit in an electrically high-resistance state is formed. At this time, the reduction is facilitated by hydrogen, whereby palladium oxide (PdO) is changed to a palladium (Pd) film.

(6) Element Activation

Since electron emission efficiency of the SCE in the state immediately after the end of the forming is very low, a process called activation is executed to the SCE so as to increase the electron emission efficiency. More specifically, in the activation, as well as the above element film forming, a cover is put on the substrate to form an adequate-pressure vacuum room in which an organic compound exists. Then, a pulse voltage is repetitively applied to the element electrodes 25 and 26 from an external power source through the X-direction wiring 23 and the Y-direction wiring 24 respectively. As the result of the activation, carbon or a carbon compound derived from the organic compound is deposited as a carbon film nearby the crack. In this process, trinitrile, which is used as a carbon source, is introduced into the vacuum room through a slow leak valve, and the voltage is applied in the state of 1.3×10⁻⁴ Pa maintained.

(7) Support Frame Forming Process

The support frame 3, which was formed by a “PD-200” glass and of which the width is 8 mm and the height is 1.2 mm, is fixed by using a glass frit on the periphery of the image display range of the rear substrate 2.

(8) Applying of Seal Bonding Material (Low-Melting Metal)

The front substrate 1 and the rear substrate 2 are put on a hot plate heated at about at 120° C., and indium (melting point: 157° C.) melted in an electric melting pot is applied, through a nozzle of which the diameter is about 4 mm, onto the sealed portion on the periphery of the image display range of the front substrate 1 and the support frame 3 fixed onto the rear substrate 2. The height of the formed indium is about 300 μm.

(9) Getter Activation Process/Seal Bonding Process

The getter activation process and the seal bonding process are executed in a vacuum chamber.

In the vacuum chamber, hot plates are disposed respectively at the opposed locations on the upper and lower walls. In such a constitution, the front substrate 1 is fixed on the upper hot plate, and the rear substrate 2 is fixed on the lower hot plate. Here, it should be noted that each of the hot plates can be moved or shifted up and down.

After the vacuum chamber was exhausted, the rear substrate 2 is baked at 380° C. in order to maintain an excellent vacuum state inside the vacuum vessel after the seal bonding. At the same time, the front substrate 1 is heated up to 430° C., and the getter activation process is executed. Here, it should be noted that the time to maintain the rear substrate 2 at 380° C. is one hour and the time to maintain the front substrate 1 at 430° C. is also one hour.

After then, the temperature of each of the front substrate 1 and the rear substrate 2 is decreased down to 170° C., the front substrate 1 is lowered. Subsequently, the seal bonding is executed so that the indium applied on the front substrate 1 and the indium applied on the support frame 3 overlap each other, thereby forming the vacuum vessel (image display device).

The SED formed in the above processes is mounted to the housing together with the driving circuit.

### Example 2

The same processes as those in the example 1 are executed except that the thickness of the getter film is set to 170 nm in the getter forming process, thereby forming the image display device according to the exemplary embodiment.

### Example 3

The same processes as those in the example 1 are executed except that the vapor deposition by electron beams is executed to Zr instead of Ti in the getter forming process, thereby forming the image display device according to the exemplary embodiment.

### Example 4

The same processes as those in the example 1 are executed except that the metal back is patterned with a metal mask (that is, the metal back is not formed on the whole image display range) and the patterned metal back is subjected to the vacuum vapor deposition only on the fluorescent members in the front substrate forming process, thereby forming the image display device according to the exemplary embodiment.

### Comparative Example 1

The same processes as those in the example 1 are executed except that the thickness of the metal back is set to 40 nm in the front substrate forming process, thereby forming the image display device according to the exemplary embodiment.

### Comparative Example 2

The same processes as those in the example 1 are executed except that the thickness of the metal back is set to 150 nm in the front substrate forming process, thereby forming the image display device according to the exemplary embodiment.

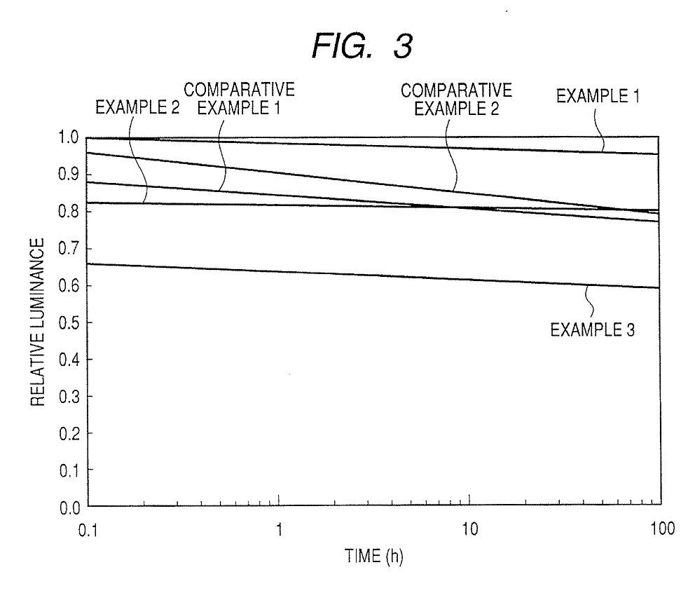

Subsequently, time-dependent changes of luminance in the examples 1 to 3 and the comparative examples 1 and 2 are compared and evaluated. More specifically, simple matrix driving is executed to cause the image display device to continuously and wholly emit light, and the time-dependent changes of luminance are measured. Here, FIG. 3 illustrates the results which are acquired by measuring the changes of luminance in the vicinity of the center of the image display range. In FIG. 3, the luminance acquired in the example 1 is set to “1”, and the luminance in each of other examples and the comparative examples is plotted as relative luminance.

Incidentally, in the matrix driving, all the X-direction wirings 23 (signal wiring) are grounded, and a voltage of −16V with a scanning frequency 600 Hz and a pulse width 20 μs is applied to the Y-direction wirings 24. At the same time, a voltage of 10 kV is applied to the metal back through the high voltage deriving terminal 4.

In FIG. 3, it is illustrated that initial relative luminance differs from others. This is because the number of electrons which pass through the respective films and reach the fluorescent member 12 differs according to the thickness of the metal back 14, the thickness of the getter 15 and the material of the getter 15. Also, this is because a reflectance of the emitted light differs from others according to the thickness of the metal back 14. If the luminance in each of the examples 1 to 3 and the comparative examples 1 and 2 are compared, it can be understood that, although the luminance in the examples 1 to 3 is lower than the luminance in the comparative examples 1 and 2 according to the constitution, a time-dependent deterioration of the luminance in the examples 1 to 3 can be suppressed as compared with a time-dependent deterioration of the luminance in the comparative examples 1 and 2. The reason why the time-dependent deterioration of the luminance in the comparative example 1 is large is that, in the getter activation process, more gases discharged from the fluorescent member 12 and the black matrix 13 reach the getter 15 because the metal back 13 is thin. In addition, the reason why the time-dependent deterioration of the luminance in the comparative example 2 is large is that, since an adsorption capability of the getter 15 depends on roughness of the surface of the metal back 14 acting as the base of the getter 15, the surface becomes smoothen is the thickness of the metal back 14 becomes thick, and thus the adsorption capability deteriorates.

This application claims the benefit of Japanese Patent Application No. 2006-146308, filed May 26, 2006 which is hereby incorporated by reference herein in its entirety.

What is claimed is:

1. An image display device comprising:
a front substrate having a fluorescent member for displaying an image, and a metal back for covering the fluorescent member;
a rear substrate having an electron emission element; and
a support frame disposed between the front substrate and the rear substrate,
wherein a thickness of the metal back is 55 nm or more and 120 nm or less, and
at least the metal back is covered with a getter.

2. An image display device according to claim 1, wherein a thickness of the getter is 40 nm or more and 200 nm or less.

3. An image display device according to claim 1, wherein the getter is an alloy including Ti, Zr, or at least one kind of Ti and Zr as a main component.
